(19) United States
(12) Patent Application Publication
(10) Pub. No.: US 2013/0072834 A1
(43) Pub. Date: Mar. 21, 2013

(54) SYSTEMS AND METHODS FOR HAPTIC SOUND WITH MOTION TRACKING

(71) Applicant: IMMERZ, INC., Cambridge, MA (US)

(72) Inventor: Shahriar S. Afshar, Boston, MA (US)

(73) Assignee: IMMERZ, INC., Cambridge, MA (US)

(21) Appl. No.: 13/673,576

(22) Filed: Nov. 9, 2012

Related U.S. Application Data
(63) Continuation-in-part of application No. 13/270,789, filed on Oct. 11, 2011.
Application No. 13/270,789 is a continuation of application No. 11/433,858, filed on May 12, 2006, now Pat. No. 8,139,803.
(60) Provisional application No. 61/629,038, filed on Nov. 10, 2011.
(60) Provisional application No. 60/708,205, filed on Aug. 15, 2005.
(60) Provisional application No. 60/716,165, filed on Sep. 12, 2005.
(60) Provisional application No. 60/737,526, filed on Nov. 16, 2005.
(60) Provisional application No. 60/755,422, filed on Dec. 31, 2005.

(51) Int. Cl. A61H 1/00

(52) U.S. Cl. CPC A61H 1/00
USPC 601/46

(57) ABSTRACT

Systems and methods for applying vibration to and tracking the position and motion of the human body. A vibration system includes a vibrator capable of converting an electrical signal into vibration, and a motion tracking device capable of tracking the motion and position of a user. In one aspect, the vibrator is arranged on or about the human body on a pectoralis major muscle and spaced away from a sternum. In another aspect, the vibrator is arranged on or about the human body such that a first pattern of vibrations are generated on the body's surface. The first pattern of vibrations matches in relative amplitude a second pattern of vibrations generated on the body's surface when the body generates sound.

### RELATED APPLICATIONS

This application claims the benefit of U.S. provisional application 61/629,038, filed Nov. 10, 2011 entitled “Shoulder-worn motion tracking apparatus,” and is a continuation-in-part of U.S. patent application Ser. No. 13/270,789, filed on Oct. 11, 2011, which is a continuation of U.S. patent application Ser. No. 11/433,858, filed on May 12, 2006 and now issued as U.S. Pat. No. 8,139,803 on Mar. 20, 2012, which claims the benefit of: U.S. provisional application 60/708205, filed Aug. 15, 2005 entitled “Vibroblast: a low-power bass speaker system that vibrates the body”, U.S. provisional application 60/716165, filed Sep. 12, 2005 entitled “ThoraPhone: method and means to deliver audio bass to the thorax and/or cervix of listener”, U.S. provisional application 60/737526, filed Nov. 16, 2005 entitled “ThoraBlast: method and means to deliver bass to the listener”, and U.S. provisional application 60/755422, filed Dec. 31, 2005 entitled “ThoraBlast: Super-immersive haptic sound technique and apparatus”, the specifications of all of the above-mentioned are incorporated by reference herein in their entirety.

### BACKGROUND

Today there are many multimedia systems that present audio and visual data to a user. As devices decrease in size and become more portable, screen size and sound quality decrease as well, adversely affecting the user's interaction with the data being presented. Existing methods for supplementing a user's experience have drawbacks which compromise the user's comfort and perception of the content being presented. For example, audio speakers intended for individual use, such as those found in headphones, are either too small to generate sound over a wide frequency range or so large as to be uncomfortable and cumbersome. Other devices attempt to compensate for speakers that are unable to generate low frequency sound by applying vibrations to the user. Many of these devices are uncomfortable or distracting to use, especially after prolonged use. For example, some devices apply vibrations to the head of the user, which can cause headaches, or to a location on the posterior side of the user, which unintentionally gives the impression the sound originates from behind the user. Furthermore, home theatre or personalized vibrating chair surround sound systems with large woofers are prohibitively expensive; and since the low frequency sound easily penetrates walls, the bass component of the sound is usually bothersome to user's neighbors, thus rendering the systems unsuitable for apartment complexes.

A need exists for systems and methods that improve the user's interaction with the content being presented. It is desirable that the system does not distract from the content being presented. It is also desirable that the system be easy to use, portable, inexpensive, and suitable for long term use.

### SUMMARY

Disclosed herein are systems and methods for applying vibration to the body of a user and to track the motion and location of the user's upper body to enhance the user's interaction with and perception of content being presented. Locations on the body for receiving vibrations are disclosed along with characteristics of locations. Illustrative embodiments of vibration systems are described, including vibrators for converting data to vibration and support structures for supporting and positioning the vibrators. Other devices that may be used in conjunction with the vibrators are described, including audio speakers, signal processors and media devices.

In one aspect of the invention, a vibration system comprises a vibrator capable of converting an electrical signal into vibration, and a motion tracking or motion capture device for tracking the movement, position and/or location of the user. The vibrator can be arranged on or about a human body on a pectoralis major muscle and spaced away from the sternum. The vibration system can include at least one of a support structure for arranging the vibrator, an audio speaker for generating sound, and a video display for generating a visual image. The vibration system may include a motion tracking or motion capture device for tracking the movement, position and/or location of the upper body of the user. Advantageously, the vibration system allows for an enhanced acoustic and haptic speaker system that is configured for tracking the motion of the user's body. The vibration system may be configured to track the movement of the upper body, separate from the movement of the user's arms. Therefore, advantageously, the vibration and motion tracking system may be hands-free, and allow for tracking motion of the body which is relatively stationary with respect to the user's head.

The vibration system can include a second vibrator arranged on or about the body on a pectoralis major muscle and spaced away from the sternum. In one configuration, the support structure disposes the vibrators on a front-back coronal plane of the body and symmetrically across a left-right median plane of the body.

In one implementation of the invention, the support structure includes at least one curved harness, with each harness adapted to fit over a shoulder of the body. Each harness can have two ends configured to flex inwardly toward each other to push a vibrator against the body. The support structure can include an adjustable endpiece that is nested within a free end of each curved harness and is capable of sliding in and out of the free end. Each curved harness can have a harness joint within its midsection that is adapted to allow a free end of each curved harness to fold towards a point of attachment of two curved harnesses. A vibrator joint can join the vibrator to a free end of a curved harness. The vibrator joint can be adapted to adjust an angle between the vibrator and the free end. A vibrator can be positioned at a point of attachment of two curved harnesses and be adapted to convert a rear channel electrical audio signal of a surround sound system into a vibration.

In another implementation of the invention, the support structure includes a bent element that is adapted to fit on a front of a shoulder of the body and has an end adapted to attach to the vibrator. A vibrator joint can join the vibrator to the bent element and be adapted to adjust an angle between the vibrator and the bent element. The support structure can include a semi-circular element that is adapted to fit around the back of the neck of the body and has two ends each adapted to attach to a bent element. A bent element joint can join a bent element to the semi-circular element and be adapted to fold the bent element and the semi-circular element together in a common plane. The support structure can include a long element vertically centered on an upper back of the body, attached to a midpoint of the semi-circular element at an angle adapted to push a vibrator against the body. A midpoint joint can join the long element to the semi-circular element and be adapted to fold the two elements together in a common plane.

In another implementation of the invention, the support structure includes a stretchable band adapted to fit over a shoulder and fastener means adapted to fasten the stretchable band to a waistband.

The vibration system can feature at least one of a pitch controller, a volume controller, a fade-in device, an amplitude-ceiling device, and a bass-enhancement device. The pitch controller can modulate a pitch characteristic of an electrical signal. The volume controller can raise and lower an amplitude characteristic of an electrical signal. The fade-in device can gradually raise an amplitude characteristic of an electrical signal. The amplitude-ceiling device can impose an upper limit on an amplitude characteristic of an electrical signal. The bass-enhancement device can sample a first electrical signal to create a sampled signal, modulate a pitch characteristic of the sampled signal to create a modulated sampled signal, and mix the modulated sampled signal with the first electrical signal. The vibration system can also feature a signal processing device capable of detecting that no electrical signal has been received for a preset amount of time, a power supply for powering a signal processing device, and an automatic shut-off device that can turn off the signal processing device in response to the signal processing device detecting that no electrical signal is being received for the preset amount of time. The vibration system can also feature a low frequency cross-over circuit capable of filtering through low frequency sound from an electrical signal and an amplifier capable of amplifying the electrical signal.

In another implementation of the invention, the vibrator includes at least one of an inertial transducer, an off-balance rotor, a tactile transducer, or a piezoelectric transducer. A surface of the vibrator can be made of at least one of synthetic rubber, foam cushion, polyurethane, speaker cover fabric, or silicone. A surface of the support structure can be made of at least one of synthetic rubber or speaker cover fabric.

In another aspect of the invention, a vibration system includes a vibrator capable of converting an electrical signal into a vibration and a support structure for arranging the vibrator. The support structure can arrange the vibrator at a location on or about a human body such that a first pattern of vibrations are generated on the body's surface, where the first pattern matches in relative amplitude a second pattern of surface vibrations generated when the body generates sound. The vibration system can include at least one of an audio speaker for generating sound and a video display for generating a visual image. The support structure can dispose a plurality of vibrators on a front-back coronal plane of the body and symmetrically across a left-right median plane of the body. The vibrator can be arranged on or about a side of a torso of the body. In one implementation of the invention, the support structure includes a stretchable band adapted to encircle a torso of the body.

### BRIEF DESCRIPTION OF THE DRAWINGS

The foregoing and other objects and advantages of the invention will be appreciated more fully from the following further description thereof, with reference to the accompanying drawings wherein:

FIG. 1 depicts a front view of vibrator locations with respect to the body's underlying musculature;

FIG. 2 depicts a front view of vibrator locations with respect to the body's underlying skeletal system;

FIG. 3 depicts a front view of vibrator locations with respect to the body's external surface;

FIGS. 4A and 4B depict, respectively, an oblique view and a side view of vibrator locations with respect to the body's anatomical planes;

FIG. 5 depicts a front view of an exemplary vibration system for experiencing audio and haptic data;

FIGS. 6A, 6B, and 6C depict, respectively, a front view, an oblique view, and a side view of an exemplary vibration device for applying vibrations to the user and capable of being used in the vibration system of FIG. 5;

FIG. 7 depicts a side view of an exemplary harness and an exemplary adjustable endpiece both capable of being used in the vibration devices of FIGS. 5-6C;

FIG. 8 depicts an oblique view of an exemplary vibrator capable of being used in the vibration devices of FIGS. 5-6C, 9-12B, and 16;

FIG. 9 depicts a front view of an exemplary vibration system for experiencing audio and haptic data;

FIGS. 10A, 10B, and 10C depict, respectively, a front view, a side view, and a top view of an exemplary vibration device for applying vibrations to the user and capable of being used in the vibration system of FIG. 9;

FIG. 11 depicts a front view of an exemplary vibration device and exemplary audio speakers being applied to the user and capable of being used in the vibration system of FIG. 9;

FIG. 12 depicts, a front view and of an exemplary vibration device for applying vibrations to the user;

FIG. 13 depicts a front view of vibrator locations with respect to the body's underlying musculature;

FIG. 14 depicts a front view of vibrator locations with respect to the body's underlying skeletal system;

FIG. 15 depicts a front view of vibrator locations with respect to the body's external surface;

FIG. 16 depicts a front view of an exemplary vibration device for applying vibrations to the user;

FIG. 17 depicts a natural surface vibration pattern that can be used to determine vibrator locations;

FIG. 18 depicts a vibrator-induced surface vibration pattern that can be used to evaluate vibrator locations;

FIGS. 19A and 19B depict views of an exemplary vibration device, for applying vibrations to the user, having one or more motion-tracking devices for tracking and capturing the position of the user; and

FIG. 20 depicts an exemplary block diagram of processing circuitry that can be used in a vibration system.

### DESCRIPTION OF ILLUSTRATED EMBODIMENTS

To provide an overall understanding of the invention, certain illustrative embodiments will now be described.

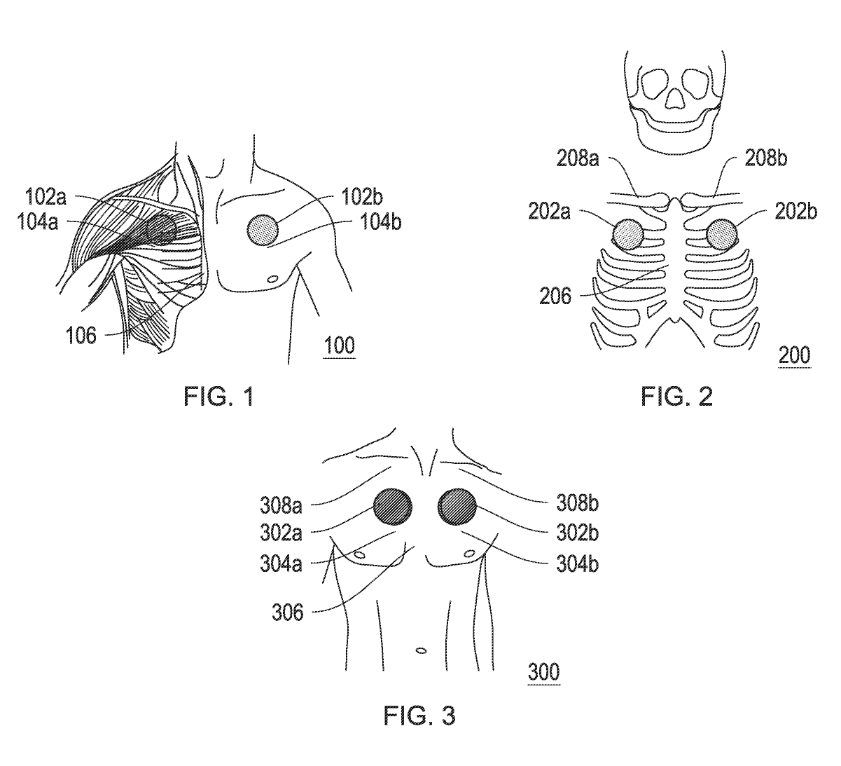

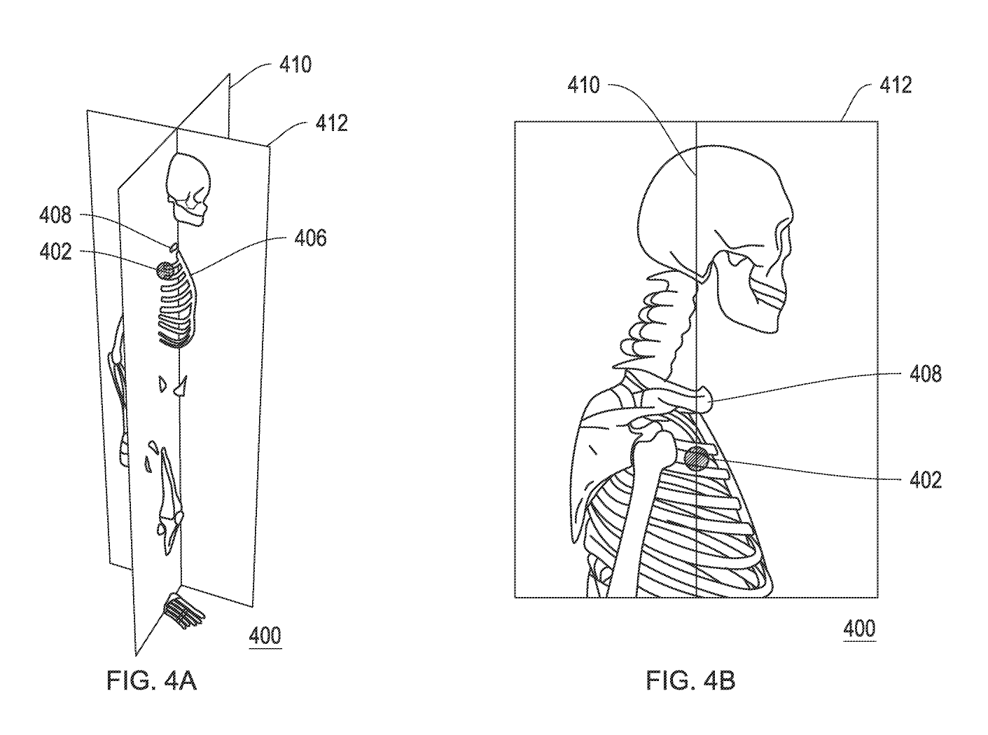

Turning to FIGS. 1-4B, there are depicted vibrator location arrangements 100, 200, 300, and 400 on a human body. In particular, FIG. 1 depicts vibrator locations 102a and 102b with respect to the body's underlying musculature. FIG. 2 depicts vibrator locations 202a and 202b with respect to the body's underlying skeletal system. FIG. 3 depicts vibrator locations 302a and 302b with respect to the body's external surface. FIGS. 4A and 4B depict, respectively, an oblique view and a side view of vibrator location 402 with respect to the body's anatomical planes.

As depicted by FIG. 1, vibrator location arrangement 100 has vibrator locations 102a and 102b disposed symmetrically across the chest of the body. A first vibrator location 102a is located adjacent to a first pectoralis major muscle 104a, and similarly a second vibrator location 102b is located adjacent to a second pectoralis major muscle 104b. Both vibrator locations 102a and 102b are spaced away from the sternum 106.

As depicted by FIG. 2, vibrator location arrangement 200 has vibrator locations 202a and 202b disposed symmetrically across the chest of the body. A first vibrator location 202a is located inferior to a first clavicle bone 208a, and similarly a second vibrator location 202b is located inferior to a second clavicle bone 208b. Both vibrator locations 202a and 202b are spaced away from the sternum 206.

As depicted by FIG. 3, vibrator location arrangement 300 has vibrator locations 302a and 302b disposed symmetrically across a chest of the body. A first vibrator location 302a is located adjacent to a first pectoralis major muscle 304a and inferior to a first clavicle bone 308a; and similarly a second vibrator location 302b is located adjacent to a second pectoralis major muscle 304b and inferior to a second clavicle bone 308b. Both vibrator locations 302a and 302b are spaced away from a sternum 306.

As depicted by FIGS. 4A and 4B, vibrator location arrangement 400 includes vibrator location 402 disposed on a front-back coronal plane 410 of the body, inferior to a clavicle bone 408, and spaced away from a sternum 406. Vibrator location arrangements can also be symmetric across the left-right median plane 412. In particular, a second vibrator location can be disposed opposite vibrator location 402 such that the two locations are symmetric with respect to the left-right median plane 412.

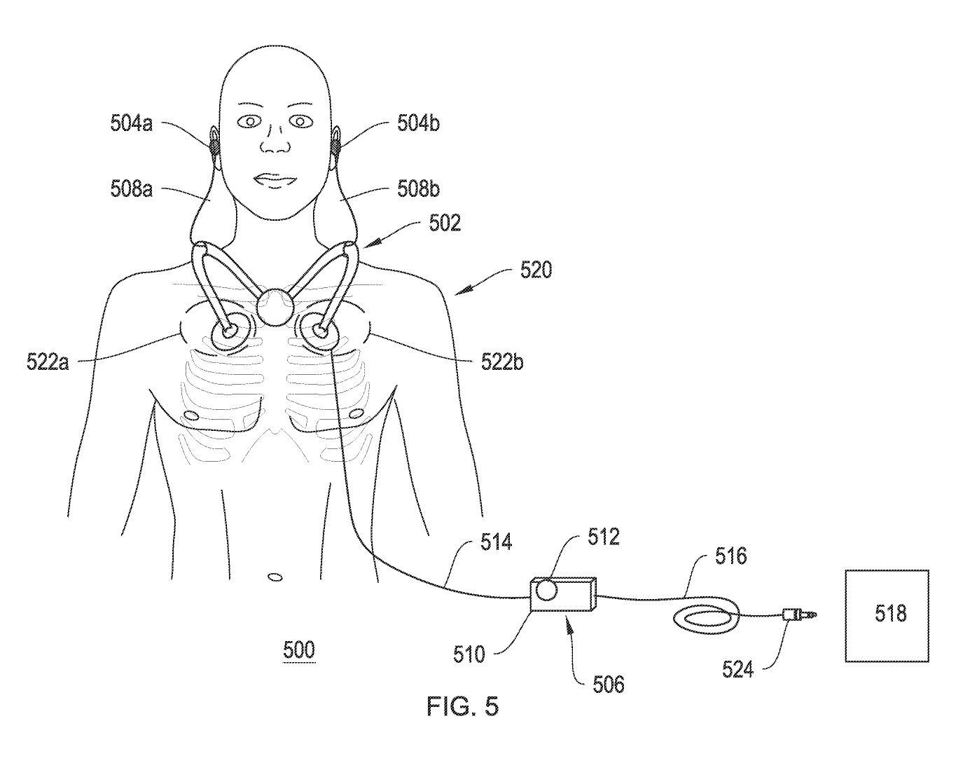

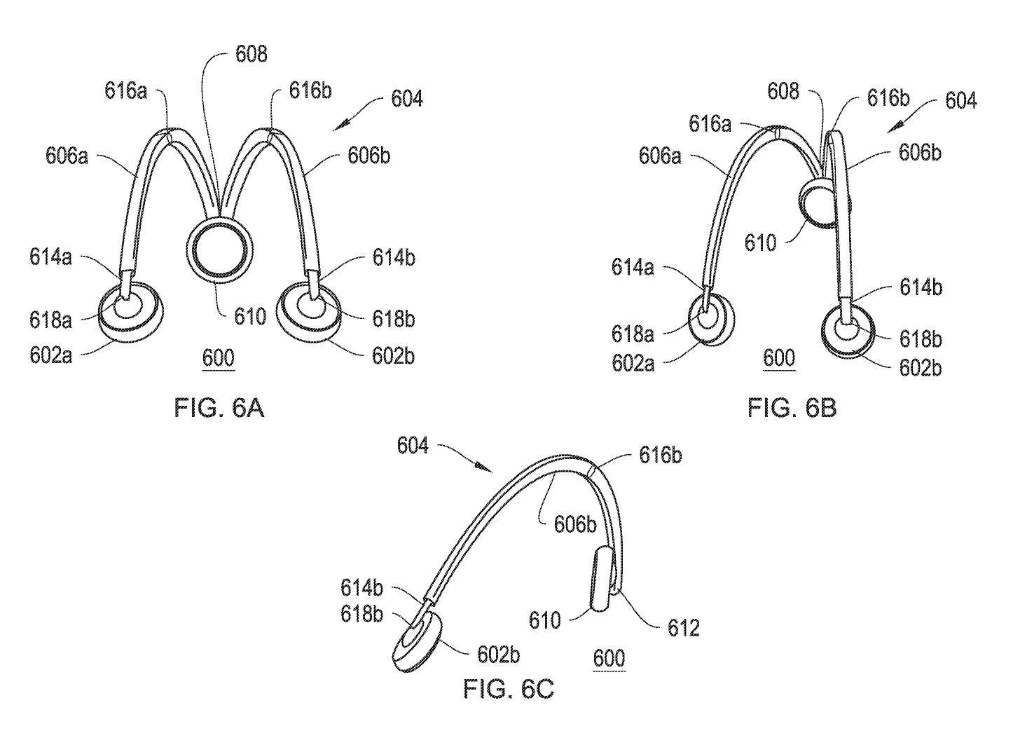

FIG. 5 depicts an exemplary vibration system 500 for experiencing audio and haptic data. The vibration system 500 is depicted on a human body 520 having vibrator locations 522a and 522b. The vibration system 500 includes a vibration device 502, optional audio speakers 504a and 504b, and a processor 506. The vibration device 502 is described below in reference to FIGS. 6A-8. The optional audio speakers 504a and 504b can be any suitable audio device, such as an earphone, headphone, or neckphone, and can be attached by wires 508a and 508b to the vibration device 502. Alternatively, the audio speakers can be separate from the vibration device 502 or the user can opt to not have or use audio speakers in conjunction with the vibration device 502.

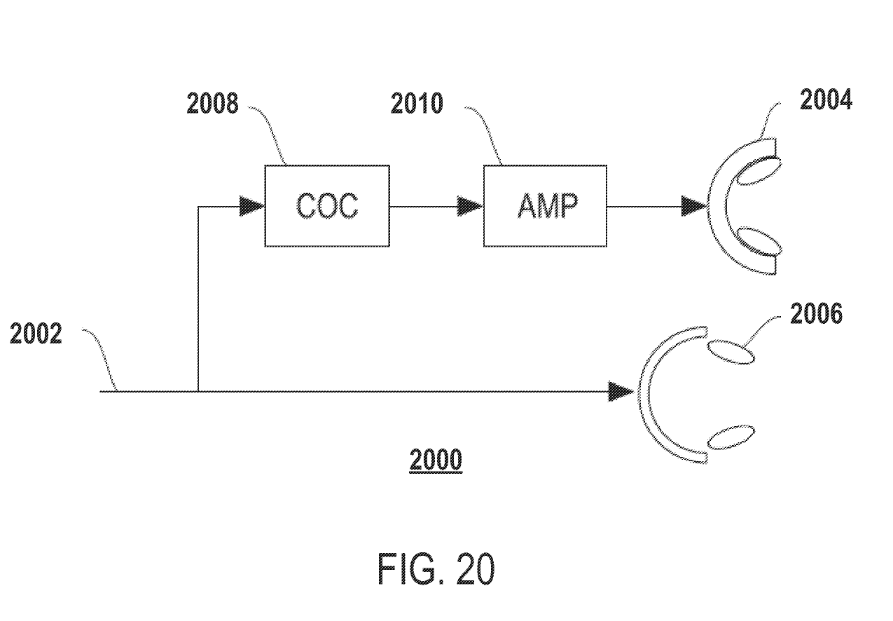

The depicted processor 506 includes a housing 510 that encases the processing circuitry, such as the processing circuitry described below in reference to FIG. 20, and supports user control interfaces such as a button, switch, or dial 512. The housing 510 can attach by wire 514 to the vibration device 502 and by wire 516 to any suitable data source 518 of audio or haptic data, such as a portable music device or video game console. The wires 514 and 516 may each have an audio jack, such as the audio jack 524 attached to the end of the wire 516, for connecting to, respectively, the processor 506 and the data source 518. Alternatively, the vibration device 502 can attach directly to a data source 518. In another alternative embodiment, the vibration device 502, the processor 506, and the data source 518 can include, respectively, a wireless receiver, a wireless transceiver, and a wireless transmitter for communicating audio or haptic data.

FIGS. 6A-8 depict in more detail an illustrative embodiment of the vibration device 502. In particular, FIGS. 6A-6C depict, respectively, a front view, an oblique view, and a side view of an exemplary vibration device 600 having two vibrators 602a and 602b positioned by a support structure 604. The vibrators 602a and 602b, described below in reference to FIG. 8, can include any suitable mechanism capable of transforming an electrical signal into vibration, such as a transducer or an off-balance rotor. The vibrators 602a and 602b attach to a support structure 604 that includes two curved harnesses 606a and 606b joined at a point of attachment 608. In particular, the vibrators 602a and 602b can attach to ends of the curved harnesses 606a and 606b, or alternatively to adjustable endpieces 614a and 614b nested within the ends of the curved harnesses 606a and 606b, via vibrator joints 618a and 618b. The curved harnesses 606a and 606b can have harness joints, respectively 616a and 616b. The point of attachment 608 can have an additional rear vibrator 610 or, alternatively, a rear cushion. The point of attachment 608 can also have an adductor joint 612.

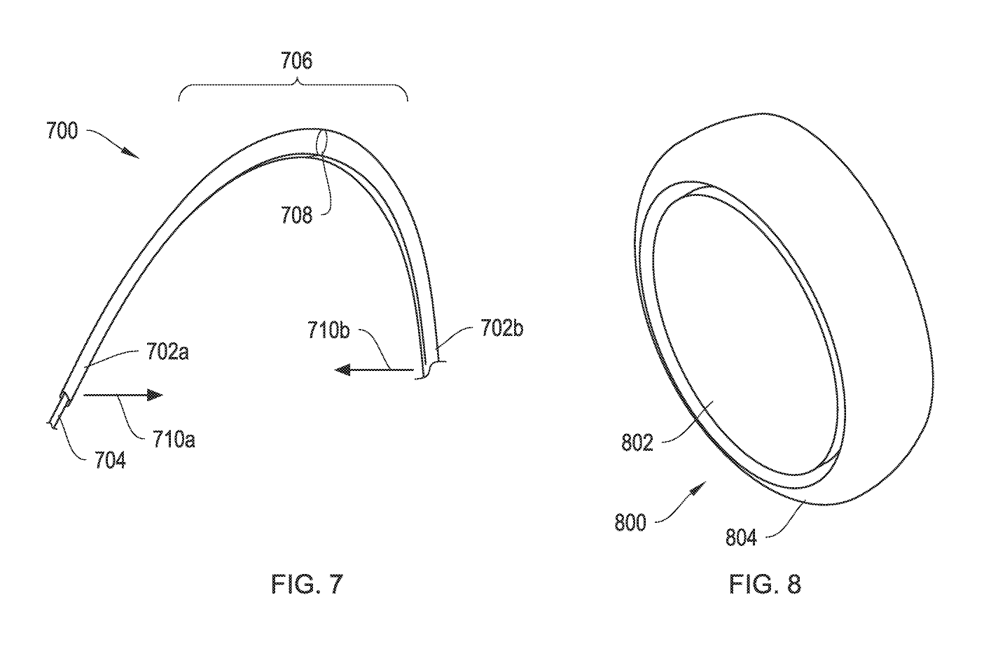

FIG. 7 depicts an exemplary curved harness 700 and adjustable endpiece 704 that can be used in the support structure 604. The curved harness 700 has two ends 702a and 702b configured to flex inwardly toward each other, as indicated by arrows 710a and 710b. The end 702a has an adjustable endpiece 704 nested within the curved harness 700. The adjustable endpiece 704 is capable of sliding in and out of the curved harness 700 to adjust a length of the curved harness 700. Between the ends 702a and 702b is a harness midsection 706, which can include a harness joint 708. The curved harness 700 and the adjustable endpiece 704 can be made of any suitably light, tensile material such as plastic, include padding such as fabric padding along their surfaces that are adjacent to the user to provide a more comfortable fit, and have external surfaces sufficiently tacky to prevent slippage when the surface rests against skin or fabrics typically used in clothing. Examples of suitable materials for their external surfaces include synthetic rubber and fabric used to cover audio speakers. The curved harness 700 can be between 10 inches and 13 inches in length and ¼ inches and 1 inch in width, while the adjustable endpiece 704 can be between 2 inches and 4 inches in length and ⅛ inches and ¾ inches in width.

FIG. 8 depicts an exemplary vibrator 800 that can be used in the vibration device 600. The vibrator 800 has a diaphragm 802 capable of vibrating in response to an electrical signal. The diaphragm 802 can be between 0.5 inches and 4 inches in diameter, with a preferred size dependent on the user's size. In particular, the diaphragm diameter can be approximately 20% of a lateral length measured from a first shoulder of the user to a second shoulder of the user. A thin cushion (not shown) can overlay the diaphragm 802 and be disposed between the diaphragm 802 and the user to soften the impact of the vibrations on the user. The thin cushion may be made of any suitable material that is sufficiently resilient and can provide padding, such as a silicone gel. An external surface of the diaphragm 802 can be any suitable material that is sufficiently tacky to prevent slippage when the external surface rests against skin or fabrics typically used in clothing. Examples of suitable materials include synthetic rubber, polyurethane, fabric used to cover audio speakers, and foam cushion used to cover headphone speakers. The surface material is typically between 1 mm and 5 mm in thickness. A cushion 804 can encircle the vibrator 800 to protect the edge of the diaphragm 802.

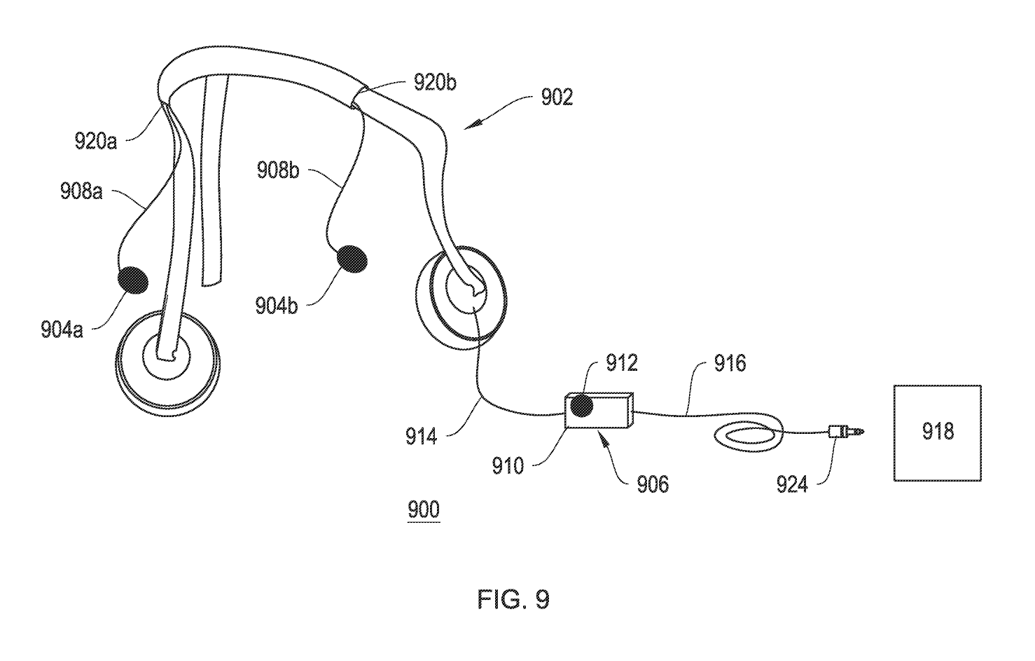

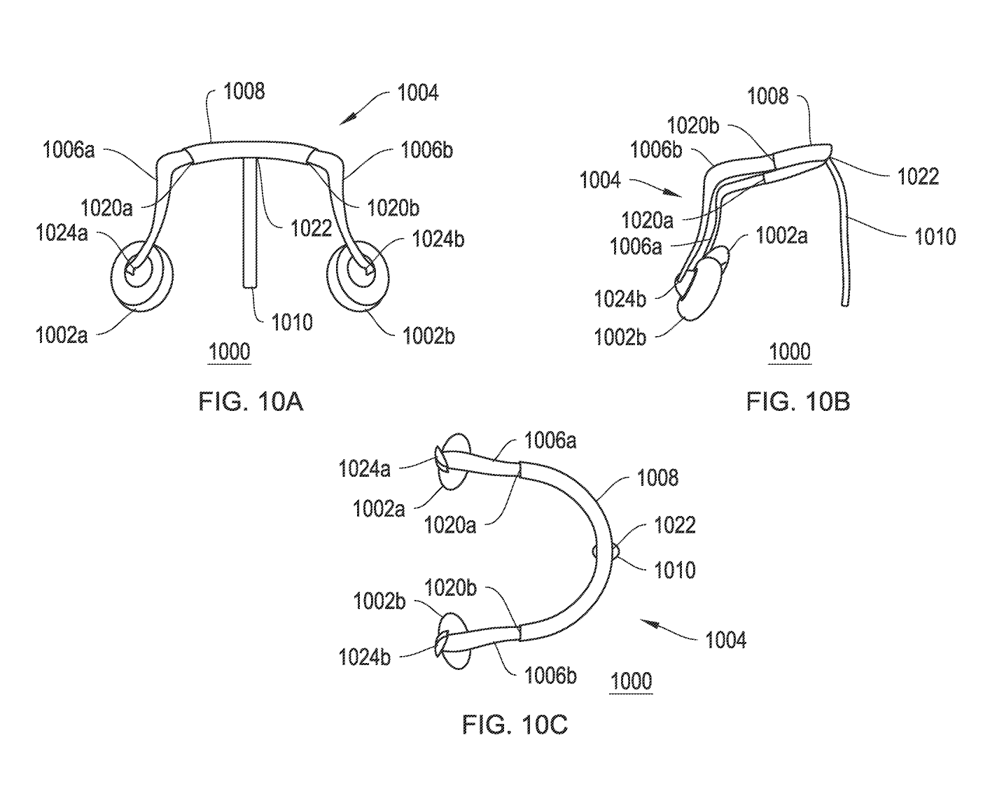

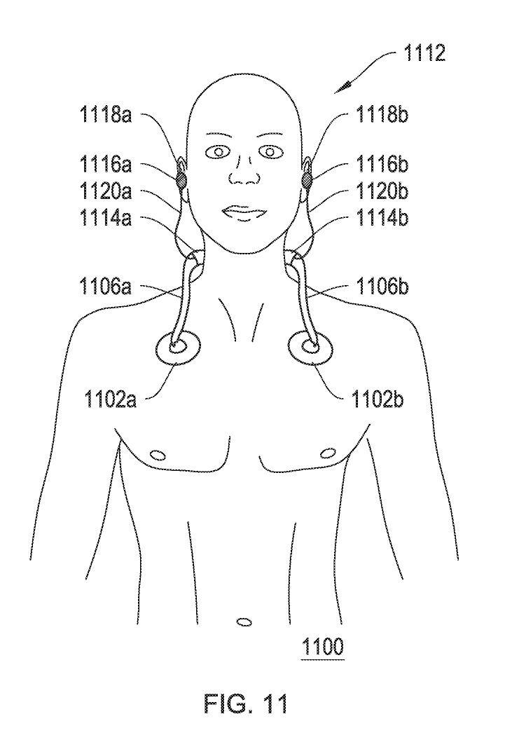

FIG. 9 depicts an exemplary vibration system 900 for experiencing audio and haptic data according to one aspect of the invention. The vibration system 900 includes a vibration device 902, optional audio speakers 904a and 904b, and a processor 906. The vibration device 902 is described below in reference to FIGS. 10A-11. The optional audio speakers 904a and 904b can be any suitable audio device, such as an earphone, headphone, or neckphone, and can be attached by wires 908a and 908b to the vibration device 902 at joints 920a and 920b. Alternatively, the audio speakers can be separate from the vibration device 902 or the user can opt to not have or use audio speakers in conjunction with the vibration device 902.

The depicted processor 906 includes a housing 910 that encases the processing circuitry, and supports user control interfaces such as a button, switch, or dial 912. The housing attaches by wire 914 to the vibration device 902 and by wire 916 to any suitable source 918 of audio or haptic data, such as a portable music device or video game console. The wires 914 and 916 may each have an audio jack, such as the audio jack 924 attached to the end of the wire 916, for connecting to, respectively, the processor 906 and the data source 918. Alternatively, the vibration device 902 can attach directly to a data source 918. In another alternative, the vibration device 902, the processor 906, and the data source 918 can include, respectively, a wireless receiver, a wireless transceiver, and a wireless transmitter for communicating audio or haptic data.

FIGS. 10A-11 depict in more detail an illustrative embodiment of the vibration device 902. In particular, FIGS. 10A-10C depict, respectively, a front view, a side view, and a top view of an exemplary vibration device 1000 having two vibrators 1002a and 1002b positioned by a support structure 1004. The vibrators 1002a and 1002b, described above in reference to FIG. 8, can include any suitable mechanism capable of transforming an electrical signal into vibration. The vibrators 1002a and 1002b attach via vibrator joints 1024a and 1024b to a support structure 1004 that includes bent elements 1006a and 1006b joined at bent element joints 1020a and 1020b to a semi-circular element 1008. The semi-circular element 1008 attaches via a midpoint joint 1022 to a long element 1010 depending vertically from a midpoint of the semi-circular element 1008. The support structure 1004 can be made of any suitably light, tensile material such as plastic and have a surface sufficiently tacky to prevent slippage when the surface rests against skin or fabrics typically used in clothing. Examples of suitable materials include synthetic rubber and fabric used to cover audio speakers.

FIG. 11 depicts a vibration device 1100 being worn by a user 1112. A semi-circular element, which is not shown, is adapted to encircle a back of a neck of the user 1112 with a long element, also not shown, centered on an upper back of the user 1112. The bent elements 1106a and 1106b are adapted to attach to vibrators 1102a and 1102b and feature bends 1114a and 1114b having an angle configured to fit on a front shoulder of the user 1112. Accompanying audio speakers can be earbuds 1116a and 1116b attached by wires 1120a and 1120b to the vibration device 1100 and adapted to fit within ears 1118a and 1118b of the user 1112.

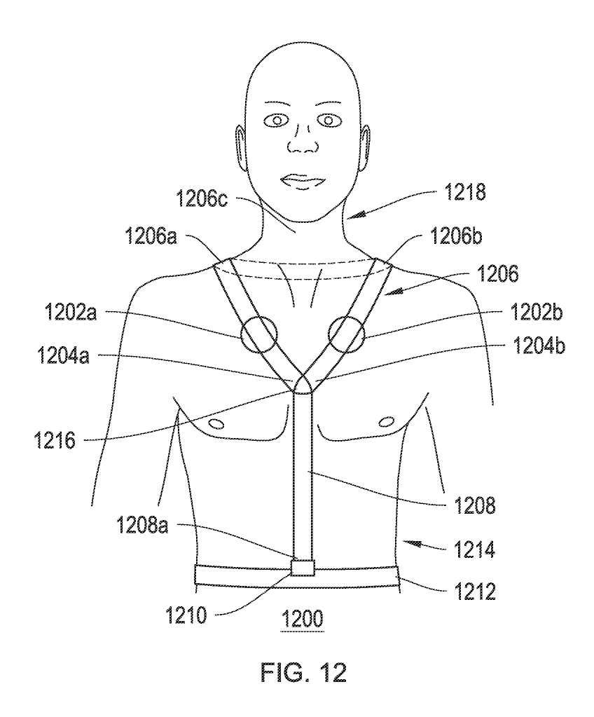

FIG. 12 depicts a front view of another exemplary vibration device 1200 being worn by a user 1214. The vibration device 1200 has two vibrators 1202a and 1202b supported by a loop of stretchable band 1206 that loops around the neck 1218 of the user. The stretchable band 1206 has two substantially symmetric front portions 1206a and 1206b, whose ends 1204a and 1204b meet at a point 1216 to form a V shaped structure adjacent to the chest of the user 1214, and a back portion 1206c that curves around the back of the neck 1218 of the user. The vibrators 1202a and 1202b, described above in reference to FIG. 8, attach to front portions 1206a and 1206b, respectively, and can include any suitable mechanism capable of transforming an electrical signal into vibration. The ends 1204a and 1204b connect to a vertical stretchable band 1208 that depends from the point 1216 to approximately the waist of the user. The stretchable bands 1206 and 1208 may be made of any suitable material that is sufficiently flexible and stretchable, such as elastic fabric. Vertical stretchable band 1208 may have a fastener 1210, attached to a free end 1208a. The fastener 1210 can be any suitable device capable of attaching to a waistband 1212 of clothing to hold the vibration device 1200 in place.

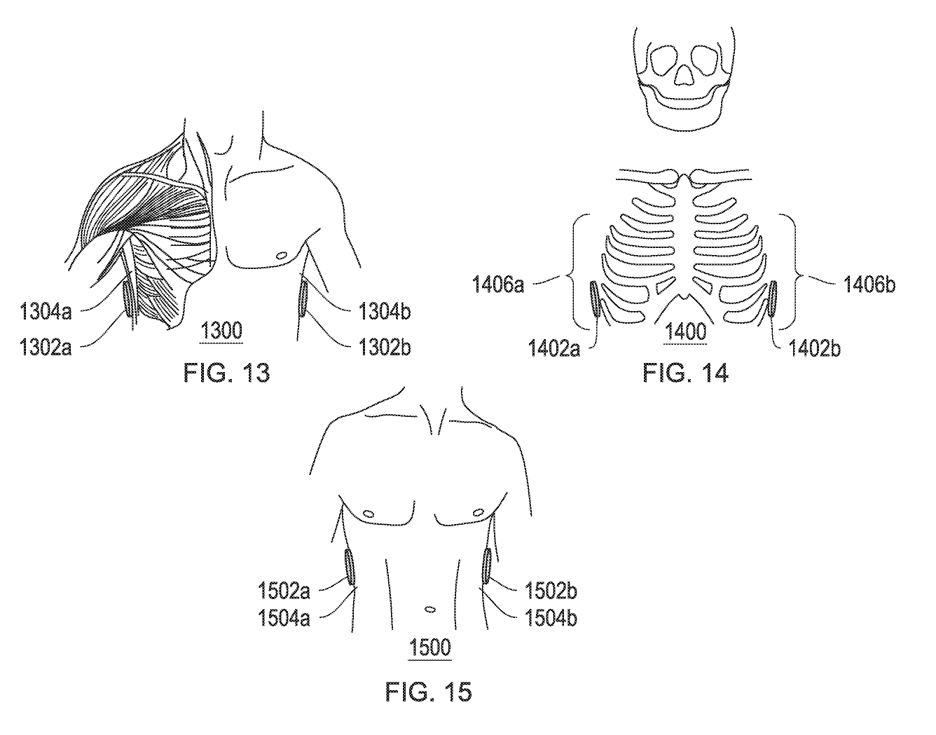

FIGS. 13-15 depict other vibrator location arrangements 1300, 1400, and 1500 on a human body. In particular, FIG. 13 depicts vibrator locations 1302a and 1302b with respect to the body's underlying musculature; FIG. 14 depicts vibrator locations 1402a and 1402b with respect to the body's underlying skeletal system; and FIG. 15 depicts vibrator locations 1502a and 1502b with respect to the body's external surface.

As depicted by FIG. 13, vibrator location arrangement 1300 has vibrator locations 1302a and 1302b disposed symmetrically across a torso of the body. A first vibrator location 1302a is located adjacent to a first abdominal external oblique muscle 1304a; and similarly a second vibrator location 1302b is located adjacent to a second abdominal external oblique muscle 1304b. Both vibrator locations 1302a and 1302b can be located on the front-back coronal plane 410, depicted in FIG. 4.

As depicted by FIG. 14, vibrator location arrangement 1400 has vibrator locations 1402a and 1402b disposed symmetrically across a torso of the body. A first vibrator location 1402a is located adjacent to a region 1406a of a rib cage which includes the third through tenth rib, known as costae verae III-X; and similarly a second vibrator location 1402b is located adjacent to a region 1406b of a rib cage which includes the third through tenth rib. Both vibrator locations 1402a and 1402b can be located on the front-back coronal plane 410, depicted in FIG. 4.

As depicted by FIG. 15, vibrator location arrangement 1500 has vibrator locations 1502a and 1502b disposed symmetrically across a torso of the body. A first vibrator location 1502a is located adjacent to a first abdominal external oblique muscle 1504a; and similarly a second vibrator location 1502b is located adjacent to a second abdominal external oblique muscle 1504b. Both vibrator locations 1502a and 1502b can be located on the front-back coronal plane 410, depicted in FIG. 4.

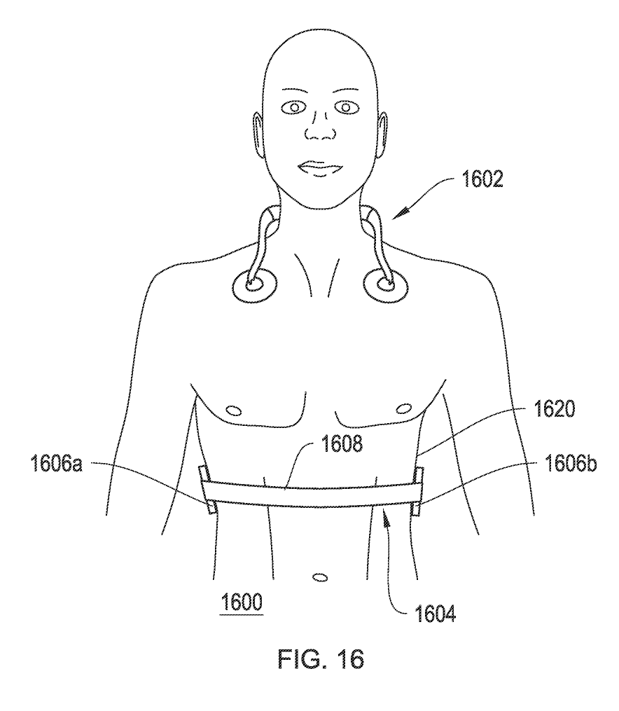

Vibrator location arrangements 1300, 1400, and 1500 may be implemented by the exemplary vibration device 1600 depicted in FIG. 16. Vibration device 1600 includes a chest vibration device 1602, which is similar to vibration devices 902, 1000, and 1100 described above and depicted in FIGS. 9-11, and a torso vibration device 1604. Alternatively, the user can opt to use the torso vibration device 1604 without the chest vibration device 1602. The torso vibration device 1604 includes a right vibrator 1606a and a left vibrator 1606b both attached to a stretchable band 1608 which encircles a torso 1620 of the human body. The vibrators 1606a and 1606b can include any suitable mechanism capable of transforming an electrical signal into vibration. The stretchable band 1608 can be made of any suitable material that is sufficiently flexible and stretchable, such as elastic fabric. The surface of the stretchable band 1608 is preferably adapted to reduce slippage when disposed on clothing or skin to prevent the torso vibration device 1604 from moving with respect to the torso 1620.

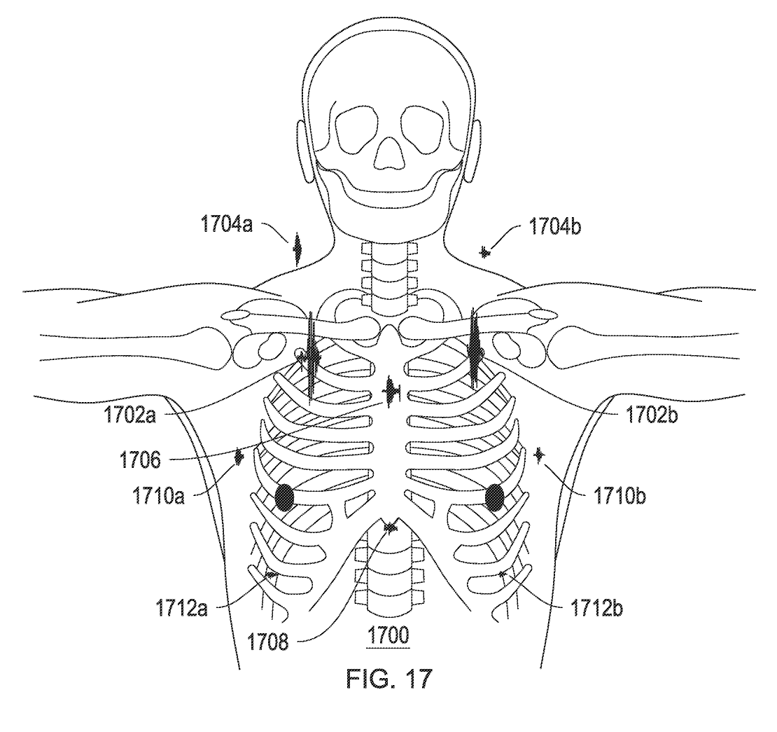

Other vibrator arrangements may also enhance a user's interaction with audio or visual content being presented. According to another aspect of the invention, one characteristic of a vibrator arrangement uses a pattern of vibrations measured on a human body's surface, called a surface vibration pattern. A natural surface vibration pattern occurs when the user generates sound, such as when the user is laughing or shouting. FIG. 17 depicts an exemplary natural surface vibration pattern 1700 of a user. In particular, FIG. 17 depicts pictorially the mechanical vibrations recorded at a variety of surface locations on the body's torso. A stethoscope was placed in contact with each surface location and coupled at its opposing end to a microphone, whose electronic signal output was recorded when the user was generating sound. Each waveform depicted in FIG. 17 represents the output recorded at that location and is sized according to the same scale to demonstrate the relative amplitudes of the surface locations. Other tests may also be suitable for measuring the surface vibrations on the body. In this example, the amplitudes are largest at symmetric pectoralis major muscle locations 1702a and 1702b, smaller at symmetric upper trapezius muscle locations 1704a and 1704b and a sternum location 1706, and smallest at a xyphoid process location 1708, underarm locations 1710a and 1710b, and sides of the ribcage locations 1712a and 1712b.

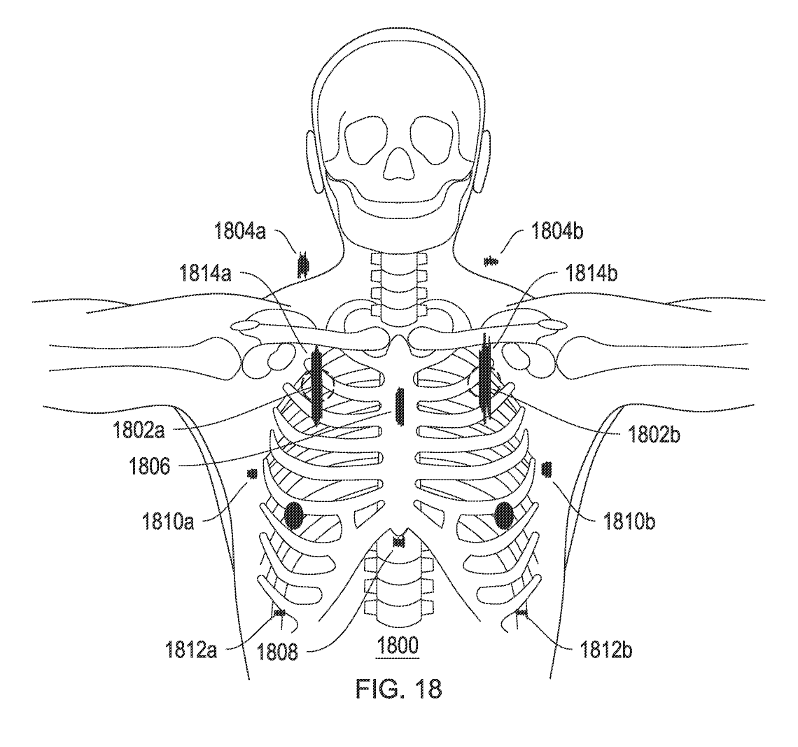

A vibrator location arrangement can induce a surface vibration pattern similar to the natural surface vibration pattern. This similarity in surface vibration patterns is preferably with respect to relative amplitudes across a variety of surface locations on the body. An exemplary vibrator-induced surface vibration pattern 1800, depicted in FIG. 18, has relative amplitudes across a set of surface locations that are similar to those of the natural surface vibration pattern 1700 depicted in FIG. 17. The amplitudes depicted in FIG. 18 were found in a similar manner to those of FIG. 17, except the microphone output was recorded when the user was using an exemplary vibration device instead of when the user was generating sound. In particular, the average amplitudes depicted in FIG. 18, like those of FIG. 17, are largest at symmetric pectoralis major muscle locations 1802a and 1802b, smaller at symmetric upper trapezius muscle locations 1804a and 1804b and a sternum location 1806, and smallest at a xyphoid process location 1808, underarm locations 1810a and 1810b, and sides of the ribcage locations 1812a and 1812b. The vibrators used to generate the vibrations of FIG. 18 were arranged in locations 1814a and 1814b, similar to vibrator location arrangements 100, 200, 300, and 400. Additional testing may be performed to determine other possible vibrator location arrangements that may create an immersive experience for the user.

Vibrator location arrangements can be symmetric with respect to the body's front-back coronal plane 410 and left-right median plane 412, depicted in FIG. 4. An arrangement of locations that is symmetric with respect to a plane may include locations that are on the plane, such as vibrator location 402, depicted in FIG. 4, which lies on the front-back coronal plane 410. Vibrator location arrangements symmetric with respect to the left-right median plane 412 include vibrator location arrangements 100, 200, 300, 1300, 1400, and 1500, depicted in FIGS. 1-3 and 13-15.

Vibrator location arrangements can space vibrators away from a sternum of the body, as depicted in vibrator location arrangements 100, 200, 300, 1300, 1400, and 1500 of FIGS. 1-3 and 13-15. Prolonged vibration of the sternum can irritate and inflame cartilage that connects the sternum to the ribs, creating a painful condition known as costochondritis.

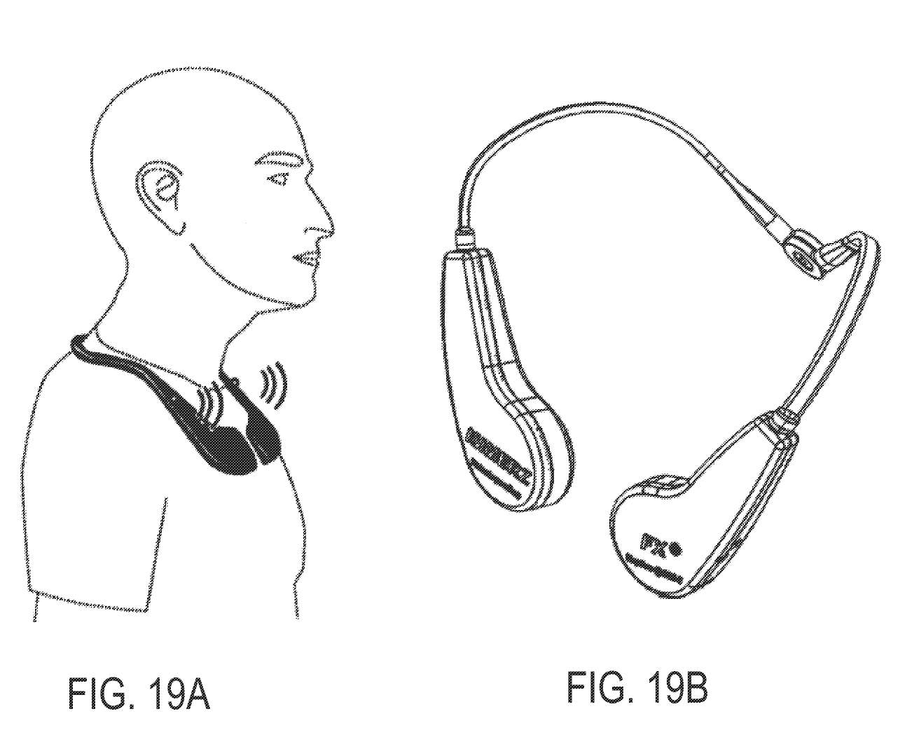

In certain embodiments, the vibration devices described herein may include one or more motion-tracking or motion-capture devices. FIGS. 19A and 19B depict on example of such a vibration device having components for tracking and capturing the position of a user. The components of the motion-tracking/motion-capture device may allow a set of data points to be extracted for the position of the head and upper trunk of the user. Advantageously, by including a motion-tracking/motion capture device in the hands-free vibration device, the systems and methods described here may be able to track the exact position of the user's body.

The motion tracking/motion capture device may include an optical device and/or a non-optical device. For example, the motion tracking/motion capture device may include passive optical devices such as reflective materials and retroreflective materials to reflect light. Cameras may then be used to reflect light off the device and determine the location of the vibration device and the user. The passive devices may be attached to a portion of the external surface of the vibration device or may be incorporated within the vibration device such that one or more reflective materials appear on the surface. The vibration device may include one or a plurality of such passive devices included on one or more vibrator locations and/or support structure of the vibration device.

The motion tracking/motion capture device may include active optical devices such as light emitting diodes (LEDs). The active optical devices may help triangulate positions by illuminating one or more LEDs on the devices themselves and determining relative positions of the devices. In certain embodiments, the active optical devices may include a plurality of LEDs that may be strobed one LED at a time, thereby allowing the systems and methods described herein to track and modulate multiple markers over time. The LEDs and/or other active devices may be attached to a portion of the external surface of the vibration device or may be incorporated within the vibration device such that one or more reflective/transmitive materials appear on the surface. The vibration device may include one or a plurality of such active devices included on one or more vibrator locations and/or support structure of the vibration device.

As noted above, in certain embodiments, the motion tracking/motion capture device may include non-optical devices such as inertial motion capture devices, mechanical motion capture devices and magnetic motion capture devices. Inertial devices may be based on miniature inertial sensors and the motion data of the inertial sensors are transmitted to a computer, where the motion is recorded or viewed. Examples of inertial devices include gyroscopes and electronic gyroscopes to measure rotational rates. The gyroscopes and/or other inertial devices may be attached to a portion of the external surface of the vibration device or may be incorporated within the vibration device. The vibration device may include one or a plurality of such non-optical devices included on one or more vibrator locations and/or support structure of the vibration device. The vibration devices may be configured with suitable hardware/software to disambiguate gyroscope measurements due to motion of the user from vibrations generated by the vibration device itself.

Other non-optical devices, such as magnetic devices, may be used to calculate the position and orientation of the user. The magnetic devices may track or capture motion based on the relative magnetic flux of three orthogonal coils on both the transmitter and the receiver. In such embodiments, the vibration device may be configured with suitable hardware/software to disambiguate magnetic device measurements from magnetic fields generated from the operation of an acoustic speaker used in connection with the vibration device. The magnetic devices may be attached to a portion of the external surface of the vibration device or may be incorporated within the vibration device. The vibration device may include one or a plurality of such non-optical devices included on one or more vibrator locations and/or support structure of the vibration device.

A vibration system as described above may receive electrical signals containing audio, haptic, and other data from a variety of media and devices. Example media include music, movies, television programs, video games, and virtual reality environments. Example devices that can provide data and be used in conjunction with a vibration device include portable music players, portable video players, portable video game consoles, televisions, computers, and home entertainment systems. Exemplary vibration systems may connect to exemplary devices via an audio jack coupled to a wire, as depicted in FIGS. 5 and 9, or may contain a wireless receiver for wirelessly receiving signals from a device equipped with a wireless transmitter.

Using a vibration device in conjunction with a media device can enhance the user's interaction with the media by creating tactile sensations that synchronize with the data being presented by the media device. For example, soundtracks that accompany movies typically have, in addition to music and dialogue, sounds that accompany the action in the movie, such as a door slamming or an explosion. The vibration device, by transforming these sounds into vibrations, allows the user to simultaneously feel this action in addition to seeing and hearing it, which can create a more immersive experience for the user. This immersive effect can be especially desirable when the visual data is poor, for example portable devices with small video screens or computer monitors with relatively low resolution. As another example, the user's perception of music may be enhanced by the vibration device, which can create a tactile sensation synchronized with the music by using the same data source as the audio speakers. This enhancement can be especially desirable for experiencing the low frequency component, also known as bass. In addition, as noted above, the vibration device may include a motion tracking/motion capture device to track the movement and location of a user. Such a vibration device with motion tracking/motion capture allows acoustic and haptic information to be directed based on the user's movement, position and/or location.

The vibration device can include processing circuitry capable of processing electrical signals for enhancing the content perceived by the user or allowing the user to modify the content. The processing circuitry may also be capable of operating and collecting data from motion tracking/motion capture devices included with the vibration device. Processing circuitry may be housed externally to the vibration device, as depicted in the embodiments of FIGS. 5 and 9, or internally within the vibration device.

Exemplary functions of processing circuitry include pitch control, volume control, fade-in, amplitude-ceiling, auto shut-off, channel separation, phase-delay, and bass enhancement, whose implementations are well-known to one skilled in the art. Pitch control allows a user to increase or decrease the overall frequency of an electrical signal. Volume control allows a user to increase or decrease the overall amplitude of an electrical signal. Fade-in gradually increases the amplitude of the beginning of an electrical signal to lessen the initial impact of vibrations on a user. Amplitude-ceiling creates an upper bound on the magnitude of the amplitude of the electrical signal to prevent the user from experiencing excessively intense vibrations. Auto shut-off turns off the processing circuitry to conserve power without receiving input from the user and when an electrical signal has not been received for a preset amount of time. Channel separation separates a stereo or multichannel signal into its component channels. Phase-delay delays a signal sent to a second vibrator with respect to a signal sent to a first vibrator to give the user the impression the sound originated from a location closer to the first vibrator than the second vibrator. Bass enhancement increases the amplitude of the bass component of an electrical audio signal relative to the rest of the signal.

Examples of multichannel signals that can be separated by processing circuitry include stereo sound, surround sound, and multichannel haptic data. Stereo sound typically uses two channels. Channel separation circuitry can separate a stereo sound two-channel electrical audio signal into a left channel signal and a right channel signal intended to be experienced by the user from, respectively, a left-hand side and a right-hand side. Multichannel electrical audio signals, such as those used in 5.1 and 6.1 surround sound, can similarly be separated, and typically contain rear channel signals intended to be experienced by the user from the rear. Channel separation circuitry can also separate multichannel haptic data, such as those used with video games or virtual reality environments, that similarly contain data intended to be experienced by the user from a specific direction.

Multiple implementations of bass enhancement are possible. An exemplary processing circuitry 2000 for bass enhancement is depicted in FIG. 20. An electrical signal is received at an input 2002 for transmitting to a vibration device 2004 and audio speakers 2006. A low frequency cross-over circuit 2008 can filter through only the bass component of the received electrical signal, whose overall amplitude is increased by an amplifier 2010 before reaching a vibration device 2004.

Another bass enhancement implementation increases the bass component without filtering out the rest of a signal. Processing circuitry can sample a received electrical signal to create a sampled signal, modulate the pitch of the sampled signal to create a modulated sampled signal, and mix the modulated sampled signal with the received electrical signal to create a signal for the vibration device. The modulation of the pitch preferably lowers the pitch of the sampled signal to increase the bass component of the signal received by the vibration device. The user may also control the degree of bass enhancement by lowering the overall frequency of a signal using pitch control.

Processing circuitry can send different signals, each based on an electrical signal received from a source of data, to different destinations. In certain embodiments, the processing circuitry can send different signals, each based on an electrical signal received from a source of data, to different destinations based on the movement, position or location of the user's body. The different destinations can include audio speakers and vibrators that are differentiated by their position relative to the body. For example, the electrical signals generated by channel separation can be transmitted to speakers or vibrators having appropriate positions relative to the body. In particular, signals intended to be experienced from the left can be sent to speakers or vibrators left of the left-right median plane, signals intended to be experienced from the right can be sent to speakers or vibrators right of the left-right median plane, signals intended to be experienced from the rear can be sent to speakers or vibrators rear of the front-back coronal plane, and signals intended to be experienced from the front can be sent to speakers or vibrators anterior of the front-back coronal plane. Exemplary vibration device 600, depicted in FIG. 6, can include a rear vibrator 610 for receiving a rear channel generated by channel separation processing circuitry. Exemplary torso vibration device 1604, depicted in FIG. 16, can include a left vibrator 1606b and a right vibrator 1606a for receiving, respectively, a left channel and a right channel generated by channel separation processing circuitry.

Processing circuitry can also combine multiple functions and can apply different sets of functions to electrical signals depending on their destinations. Preferably, signals sent to vibrators have undergone bass enhancement. For example, the embodiment 2000 depicted in FIG. 20 applies a bass enhancement implementation 2008 and 2010 to an electrical signal destined for a vibration device 2004, and applies a direct coupling between the input 2002 and an electrical signal destined for audio speakers 2006. Different speakers and vibrators may also each have individual controllers to allow the user more flexibility in controlling the immersive experience.

Once the electrical signals have been processed, the modified electrical signals can be transmitted to a vibration device, exemplified by vibration devices 502, 902, 1200, and 1600 depicted in, respectively, FIGS. 5, 9, 12, and 16. The vibration devices have vibrators capable of transforming received electrical signals into mechanical movement. The mechanical movement can take the form of a vibration whose amplitude and frequency match those of the received electrical signal. In a preferred embodiment, the vibrator has a flat or concave surface, called a diaphragm, that vibrates to create the matching mechanical movement. Examples of mechanisms capable of generating vibration in response to an electrical signal include an inertial transducer, a piezoelectric transducer, a tactile transducer, and a motor with an off-balance rotor.

The support structure of the vibration device can serve multiple purposes for insuring the vibration device imparts an immersive experience to the user. The support structure can dispose vibrators in vibrator location arrangements and insure the vibrators can transfer vibration to the user. Other support structure qualities include a comfortable fit, ease of use, and an inconspicuous presence when worn.

The support structure of the vibration device can be configured to position vibrators according to vibrator location arrangements, such as those described above and in reference to FIGS. 1-4 and 13-15. For example, the support structure of the vibration device 502 depicted in FIG. 5 positions vibrators in vibrator locations 522a and 522b. Similarly, the support structure 604 depicted in FIGS. 6A-6C can position the vibrators 602a and 602b according to vibrator location arrangements 100, 200, 300, and 400 depicted in FIGS. 1-4. The user can also adjust the positioning of the vibrators by using the adductor joint 612 to adjust the harnesses 606a and 606b laterally and the adjustable endpieces 612a and 612b to adjust the length of the harnesses 606a and 606b. The support structure 1004 depicted in FIG. 10 and the suspenders 1204 depicted in FIG. 12 can position vibrators, respectively, 1002a and 1002b, and 1202a and 1202b, also according to vibrator location arrangements 100, 200, 300, and 400 depicted in FIGS. 1-4. The stretchable band 1608 of the torso vibration device 1604 depicted in FIG. 16 can position vibrators 1606a and 1606b according to vibrator location arrangements 1300, 1400, and 1500.

The support structure can also be configured to align a diaphragm 802 of a vibrator 800, depicted in FIG. 8, substantially parallel to a surface of the user at the vibrator location to insure that as much as possible of the diaphragm 802 is in contact with the user. For example, the support structure 604 depicted in FIGS. 6A-6C has vibrator joints 618a and 618b capable of adjusting the angle at which the vibrators 602a and 602b are oriented. The user can adjust the vibrators 602a and 602b to an angle that orients the diaphragms of the vibrators 602a and 602b substantially parallel to the surface of the chest of the user 520 at vibrator locations 522a and 522b depicted in FIG. 5. Similarly, the support structure 100 depicted in FIGS. 10A-10C has vibrator joints 1020a and 1020b capable of adjusting the angle at which the vibrators 1002a and 1002b are oriented.

The support structure can also be configured to push the vibrators against the body to insure the user can sense the vibrations of the vibrators. Support structures that include tensile elements can have rigidity sufficient to push the vibrators against the body. For example, the support structure 604 depicted in FIGS. 6A-6C has curved harnesses 606a and 606b configured to flex inwardly, which pushes the vibrators 602a and 602b against the body. In another example, the support structure 1004 depicted in FIG. 10 includes a long element 1010 attached to a semi-circular element 1008. The angle between the long element 1010 and a plane of the semi-circular element 1008 is preferably sufficiently acute to push the vibrators 1002a and 1002b against the body. Other embodiments contain non-tensile support structures configured to push the vibrators. For example, support structures that include stretchable bands, such as the suspenders 1204 depicted in FIG. 12 and the stretchable band 1608 depicted in FIG. 16, can be made of an elastic material. The elasticity of the stretchable bands pushes the vibrators 1202a, 1202b, 1606a, and 1606b against the body.

The support structures described herein can be configured to fit snugly without being too compressive on the body, are straightforward to put on over the shoulders or around the torso, and can be worn underneath clothing without significantly altering the profile of the clothing.

Embodiments of the vibration device may also be foldable to facilitate storage and portability of the device. Vibration device support structures that can be made of fabric, such as the suspenders 1204 depicted in FIG. 12 and the stretchable band 1608 of the torso vibration device 1604 depicted in FIG. 16, can easily fold into a myriad of shapes. Vibration devices made of a more rigid material can have joints or hinges for facilitating folding.

For example, exemplary vibration device 600 depicted in FIGS. 6A-6C can have joints 612, 616a, and 616b adapted for folding up the vibration device 600. In particular, the adductor joint 612 can adduct the two harnesses 616a and 616b together; and the harness joints 616a and 616b can allow the vibrators 602a and 602b, respectively, to fold towards the point of attachment 608. The joints 612, 616a, and 616b preferably have one degree of freedom and can be spring-loaded.

Similarly, exemplary vibration device 1000 depicted in FIGS. 10A-10C can have joints 1020a, 1020b, and 1022 adapted for folding the vibration device 1000 into substantially the same plane as the semi-circular element 1008. In particular, the bent element joints 1020a and 1020b can allow the bent elements 1006a and 1006b to fold upward and inward; and the midpoint joint 1022 can allow the long element 1010 to fold upward and inward. The joints 1020a, 1020b, and 1022 preferably have one degree of freedom and can be spring-loaded.

The foregoing embodiments are merely examples of various configurations of components of vibration systems described and disclosed herein and are not to be understood as limiting in any way. Additional configurations can be readily deduced from the foregoing, including combinations thereof, and such configurations and continuations are included within the scope of the invention. Variations, modifications, and other implementations of what is described may be employed without departing from the spirit and the scope of the invention. More specifically, any of the method, system and device features described above or incorporated by reference may be combined with any other suitable method, system, or device features disclosed herein or incorporated by reference, and is within the scope of the contemplated inventions.

I claim:

1. A vibration system, comprising:
a vibrator capable of converting an electrical signal into vibration, arranged on or about a human body on a pectoralis major muscle and spaced away from a sternum, and
a motion tracking device disposed on the vibrator and configured to track at least one of the position or movement of the human body.

2. The system of claim 1, further comprising a support structure for arranging the vibrator.

3. The system of claim 1, further comprising an audio speaker for generating sound.

4. The system of claim 1, further comprising a second vibrator arranged on or about the body on a pectoralis major muscle and spaced away from the sternum.

5. The system of claim 4, wherein the support structure disposes the vibrators on a front-back coronal plane of the body and symmetrically across a left-right median plane of the body.

6. The system of claim 2, wherein the support structure includes a curved harness adapted to fit over a shoulder of the body and having two ends configured to flex inwardly toward each other.

7. The system of claim 6, wherein the support structure includes a second curved harness adapted to fit over a shoulder of the body and having two ends configured to flex inwardly toward each other.

8. The system of claim 7, wherein the two ends of each curved harness are adapted to flex inwardly and push a vibrator against the body.

9. The system of claim 8, further comprising an adjustable endpiece nested within a free end of each curved harness and capable of sliding in and out of the free end.

10. The system of claim 8, further comprising an adductor joint at a point of attachment of the two curved harnesses, adapted to adduct the two curved harnesses.

11. The system of claim 8, further comprising a harness joint at a midsection of each curved harness adapted to allow a free end of each curved harness to fold towards a point of attachment of the two curved harnesses.

12. The system of claim 8, further comprising a vibrator joint at a point of attachment of a vibrator to a free end of a curved harness, adapted to adjust an angle between the vibrator and the free end.

13. The system of claim 8, further comprising a vibrator positioned at a point of attachment of the two curved harnesses, adapted to convert a rear channel electrical audio signal of a surround sound system into a vibration.

14. The system of claim 2, wherein the support structure includes a bent element adapted to fit on a front of a shoulder of the body and having an end adapted to attach to the vibrator.

15. The system of claim 14, further comprising a vibrator joint at a point of attachment of the vibrator to the bent element, adapted to adjust an angle between the vibrator and the bent element.

16. The system of claim 14, wherein the support structure includes a semi-circular element adapted to fit around a back of a neck of the body and having two ends each adapted to attach to a bent element.

17. The system of claim 16, further comprising a bent element joint at a point of attachment of a bent element to the semi-circular element, adapted to fold the bent element and the semi-circular element together in a common plane.

18. The system of claim 16, wherein the support structure includes a long element vertically centered on an upper back of the body, attached to a midpoint of the semi-circular element at an angle adapted to push a vibrator against the body.

19. The system of claim 18, further comprising a midpoint joint at a point of attachment of the long element to the semi-circular element, adapted to fold the two elements together in a common plane.

20. The system of claim 2, wherein the support structure includes a first stretchable band adapted to fit around a neck, a second stretchable band connected to the first stretchable band and adapted to depend from the first stretchable band, and a fastener adapted to fasten the second stretchable band to a waistband.

21. The system of claim 1, further comprising a video display for generating a visual image.

22. The system of claim 1, further comprising a pitch controller capable of modulating a pitch characteristic of an electrical signal.

23. The system of claim 1, further comprising a volume controller capable of raising and lowering an amplitude characteristic of an electrical signal.

24. The system of claim 1, further comprising a fade-in device capable of gradually raising an amplitude characteristic of an electrical signal.

25. The system of claim 1, further comprising an amplitude-ceiling device capable of imposing an upper limit on an amplitude characteristic of an electrical signal.

26. The system of claim 1, further comprising
a signal processing device capable of detecting that no electrical signal has been received for a preset amount of time,
a power supply for powering a signal processing device, and
an automatic shut-off device capable of turning off the signal processing device in response to the signal processing device detecting that no electrical signal is being received for the preset amount of time.

27. The system of claim 1, further comprising a bass-enhancement device capable of sampling a first electrical signal to create a sampled signal, modulating a pitch characteristic of the sampled signal to create a modulated sampled signal, and mixing the modulated sampled signal with the first electrical signal.

28. The system of claim 1, further comprising
a low frequency cross-over circuit capable of filtering through low frequency sound from an electrical signal, and
an amplifier capable of amplifying the electrical signal.

29. The system of claim 1, wherein the vibrator includes at least one of an inertial transducer, an off-balance rotor, a tactile transducer, or a piezoelectric transducer.

30. The system of claim 1, wherein a surface of the vibrator is made of at least one of synthetic rubber, silicone, foam cushion, or speaker cover fabric.

31. The system of claim 2, wherein a surface of the support structure is made of at least one of synthetic rubber or speaker cover fabric.

32. The system of claim 1, wherein the motion tracking device includes at least one of an optical device and non-optical device.

33. The system of claim 32, wherein the motion tracking device includes an active optical device including a light emitting diode (LED).

34. The system of claim 32, wherein the motion tracking device includes an inertial device including a gyroscope.

35. The system of claim 34, wherein the gyroscope includes an electronic gyroscope.
